(19) United States
(12) Patent Application Publication
(10) Pub. No.: US 2009/0053683 A1
(43) Pub. Date: Feb. 26, 2009

(54) Flexible Member Based Simulator

(75) Inventors: J. Michael Brown, Washington, DC (US); Robert F. Cohen, Kensington, MD (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Immersion Medical, Inc., Gaithersburg, MD (US)

(21) Appl. No.: 11/844,576

(22) Filed: Aug. 24, 2007

(51) Int. Cl. G09B 23/32

(52) U.S. Cl. 434/272

(57) ABSTRACT

A simulator includes a motor and a flexible member coupled to the motor. The simulator further includes a processor that is coupled to the motor and controls the motor to vary the tension of the flexible member.

### FIELD OF THE INVENTION

One embodiment of the present invention is directed to a haptic feedback system. More particularly, one embodiment of the present invention is directed to a haptic feedback system that utilizes a flexible member.

### BACKGROUND INFORMATION

Device manufacturers strive to produce a rich interface for users. Conventional devices use visual and auditory cues to provide feedback to a user. In some interface devices, kinesthetic feedback (such as active and resistive force feedback) and/or tactile feedback (such as vibration, texture, and heat) is also provided to the user, more generally known collectively as “haptic feedback” or “haptic effects”. Haptic feedback can provide cues that enhance and simplify the user interface.

Some devices need to provide haptic effects that simulate a physical interaction with an object that includes a sense of depth. For example, in the medical field, a fairly common procedure is the insertion of a central venous catheter (“CVC”) into a large vein in the neck, chest or groin. The catheter is inserted by a physician when the patient needs more intensive cardiovascular monitoring, for assessment of fluid status, and for increased viability of intravenous drugs/fluids. The most commonly used veins are the internal jugular vein, the subclavian vein and the femoral vein.

When performing a CVC insertion, it is very important for the physician to locate the correct vein, rather than inserting the catheter in a nearby lung or other vital organ. To find the correct vein, the physician typically performs a palpation on the adjacent tissue area. Therefore, the physician must have experience to detect the feeling of the proper area to insert the catheter, and to detect the feeling of the improper area. In order to get the adequate amount of experience, it is useful for the physician to practice on a medical simulator rather than a live patient. However, the simulator must adequately provide a surface that generates haptic effects that duplicate the sense of depth and density that a physician would expect to feel on a live patient

Based on the foregoing, there is a need for a haptic device that simulates a physical interaction with an object that includes a sense of depth.

### SUMMARY OF THE INVENTION

One embodiment is a simulator that includes a motor and a flexible member coupled to the motor. The simulator further includes a processor that is coupled to the motor and controls the motor to vary the tension of the flexible member.

### BRIEF DESCRIPTION OF THE DRAWINGS

FIG. 1 is a block diagram of one embodiment of a flexible member based simulator.

FIG. 2 is a block diagram of the simulator in accordance to one embodiment and is an example of when the tension on the flexible member is less than the tension in FIG. 1.

FIG. 3 is a flow diagram of the functionality of the simulator in accordance with one embodiment when a user is manipulating an interface device.

FIG. 4 is a block diagram of a flexible member based simulator in accordance with another embodiment.

FIG. 5 is a block diagram of a flexible member based simulator in accordance with another embodiment.

### DETAILED DESCRIPTION

One embodiment is a simulator that uses a flexible member with adjustable tension to simulate an object that includes a sense of depth and density.

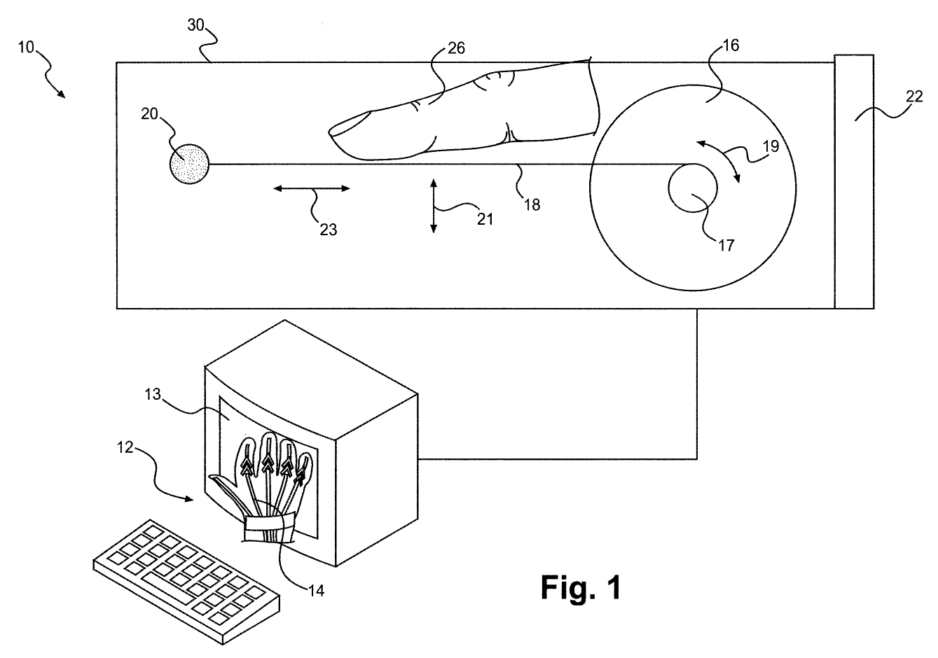

FIG. 1 is a block diagram of one embodiment of a flexible member based simulator 10. Simulator 10 includes an interface device 30 coupled to a processor 12 that may be part of an overall computer system. Processor 12 is coupled to memory (not shown), and a screen 13 that displays an object 14 to be simulated. In the embodiment of FIG. 1, the object is a hand, but could be any other portion of a body or any other type of object. Processor 12 can be any type of general or specific purpose processor or controller.

Interface device 30 is a device that interfaces with a user's finger 26 or other body portion of the user. Interface device 30, similar to a computer mouse, is adapted to slide over a smooth surface. Interface device 30 includes a motor or actuator 16 coupled to a flexible member 18. Motor 16 includes an axle 17 that rotates in either direction as indicated by arrow 19. In one embodiment, motor 16 is a direct current (“DC”) brushed motor. Motor 16 includes a position sensor (not shown) that provides the position of axle 17 to processor 12. In one embodiment, the position sensor is an optical encoder. Interface device 30 further includes an optical sensor 22 that tracks the motion of device 30 as it slides over a surface. Other types of sensors, including a mechanical ball or a force sensor can also be used in other embodiments to track the motion of device 30 or to track the motion of the finger or other object.

Flexible member 18 is further coupled to a post 20 and is wrapped at least partially around axle 17. A spring (not shown) may be inserted between post 20 and flexible member 18 to modify the flexible properties of flexible member 18. Flexible member 18 can be any type of elongated object that is flexible in the vertical direction, indicated by arrow 21. In one embodiment, flexible member 18 should be generally stiff and inflexible in the horizontal direction, indicated by arrow 23. Examples of materials that can be used for flexible member 18 include wire, cable, tape, fabric, leather, etc. Different materials may be used based at least in part on the desired flexibility in the vertical direction and the feel of the surface of member 18 on finger 26 of the user.

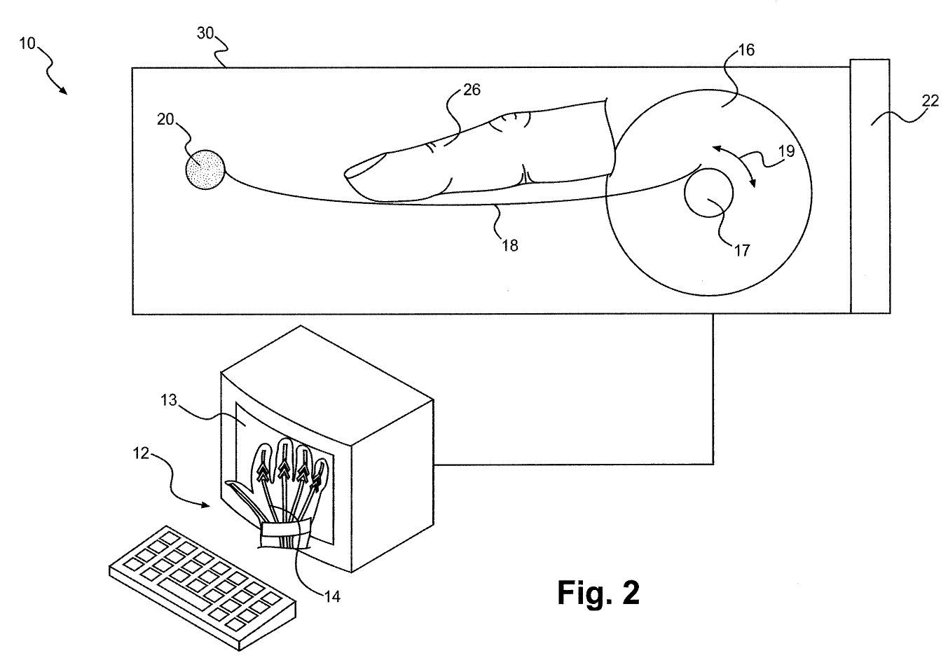

Processor 12 transmits signals that control motor 16, and specifically control the rotation of axle 17, which controls the tension on flexible member 18. FIG. 1 is an example of when the tension on flexible member 18 is high, and thus flexible member 18 will feel generally stiff and hard to finger 26. FIG. 2 is a block diagram of simulator 10 in accordance to one embodiment and is an example of when the tension on flexible member 18 is less than the tension in FIG. 1. Therefore, flexible member 18 will feel softer and more compliant to finger 26 when it is in the position of FIG. 2 as compared to FIG. 1.

In operation, a user rests a finger 26 on flexible member 18. The object to be simulated is displayed on screen 13. In one embodiment, the object is hand 14. As the user moves interface device 30 over a smooth surface, the motion of device 30, including flexible member 18, is tracked on hand 14 so it appears that the user is moving finger 26 over hand 14 or that the user is performing a palpation on the simulated object on screen 13. The movement of interface device 30 will cause the user to “point” to an area of hand 14. When device 30 is being moved, processor 12 controls motor 16 so that the tension on flexible member 18 changes depending on the area of hand 14 that the user is “touching” or pointing to. For example, if it appears on screen 13 that the user is on an area of hand 14 that has an underlying bone, tension on member 18 may be increased to simulate the stiffness and density of the bone. If it appears on screen 13 that the user is on an area of hand 14 having soft tissue, tension on member 18 may be decreased to simulate the stiffness and density of the soft tissue. If it appears on screen 13 that the user is on an area of hand 14 having a blood vessel, the tension on member 18 may be alternatively increased and decreased to simulate the pulsation of blood within the vessel.

Although simulator 10 as illustrated in FIG. 1 includes only one flexible member, any number of flexible members may be used. For example, an interface device can include five flexible members, one for each finger on a hand. In one embodiment, each flexible member will be coupled to a separate motor so that the tension on each can be individually controlled.

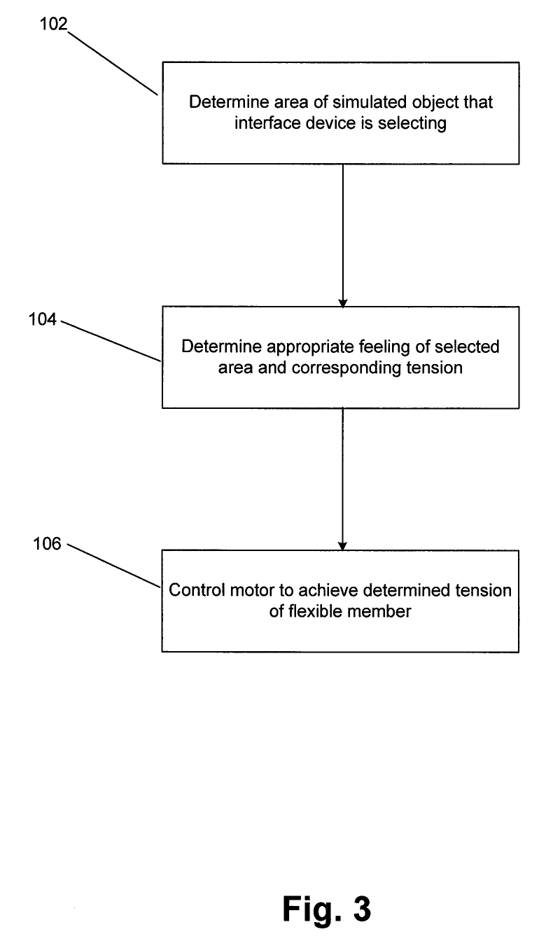

FIG. 3 is a flow diagram of the functionality of simulator 10 in accordance with one embodiment when a user is manipulating interface device 30. In one embodiment, the functionality of the flow diagram of FIG. 3 is implemented by software stored in memory and executed by a processor. In other embodiments, the functionality can be performed by hardware, or any combination of hardware and software.

At 102, the area of simulated object that interface device 30 is selecting or pointing to is determined. In one embodiment, optical sensor 22 tracks the movement of interface device 30 and sends the movement information to processor 12.

At 104, processor 12 determines what the selected area should feel like to a user when touched by a finger or other object. In one embodiment, each pixel of hand 14 can be linked in a look up table to the appropriate feeling. For example, if a pixel is a portion of a bone, the feeling could be maximum hardness. If the pixel is a ligament, the feeling could be less hardness. The tension for flexible member 18 to generate the determined feeling is also determined.

At 106, processor 12 controls motor 16 which rotates axle 17 to achieve the determined tension of flexible member 18. The change in tension is felt by the user by finger 26, and corresponds to the simulated feeling of the area pointed to by interface device 30.

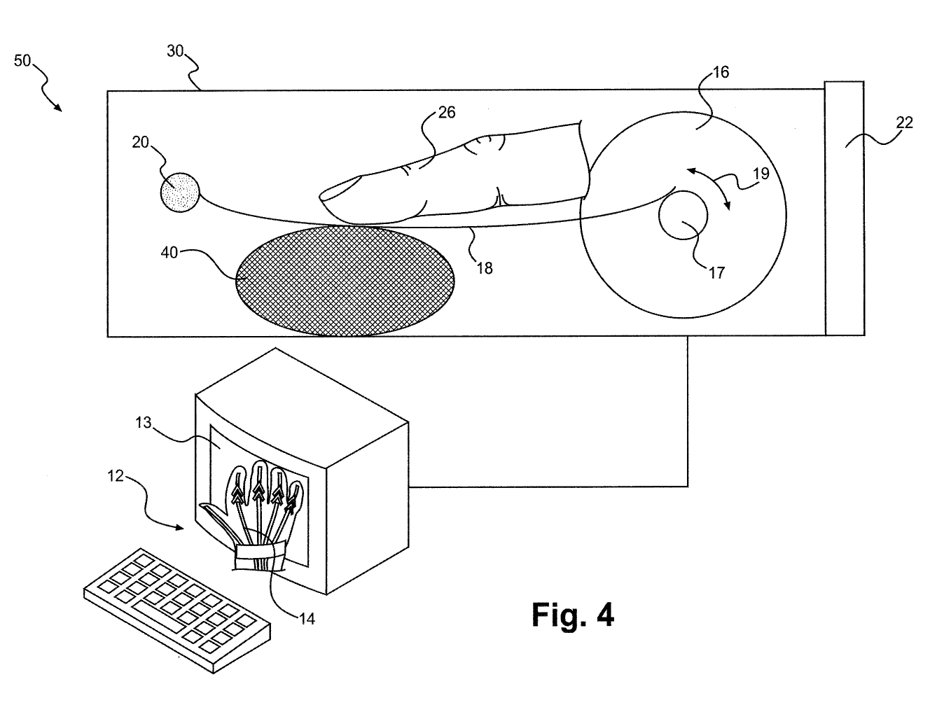

FIG. 4 is a block diagram of a flexible member based simulator 50 in accordance with another embodiment. Simulator 50 is similar to simulator 10 with the addition of a contact object 40 below flexible member 18 and positioned so flexible member 18 contacts object 40 at some level of tension. Contact object 40 can be formed from a hard material so simulator 50 can better simulate the feeling of hard bone under soft tissue. In one embodiment, object 40 can be different shapes and different materials to simulate the feel of different tumors under skin to allow a user to be trained on how to feel for tumors and differentiate between different types of tumors via feel.

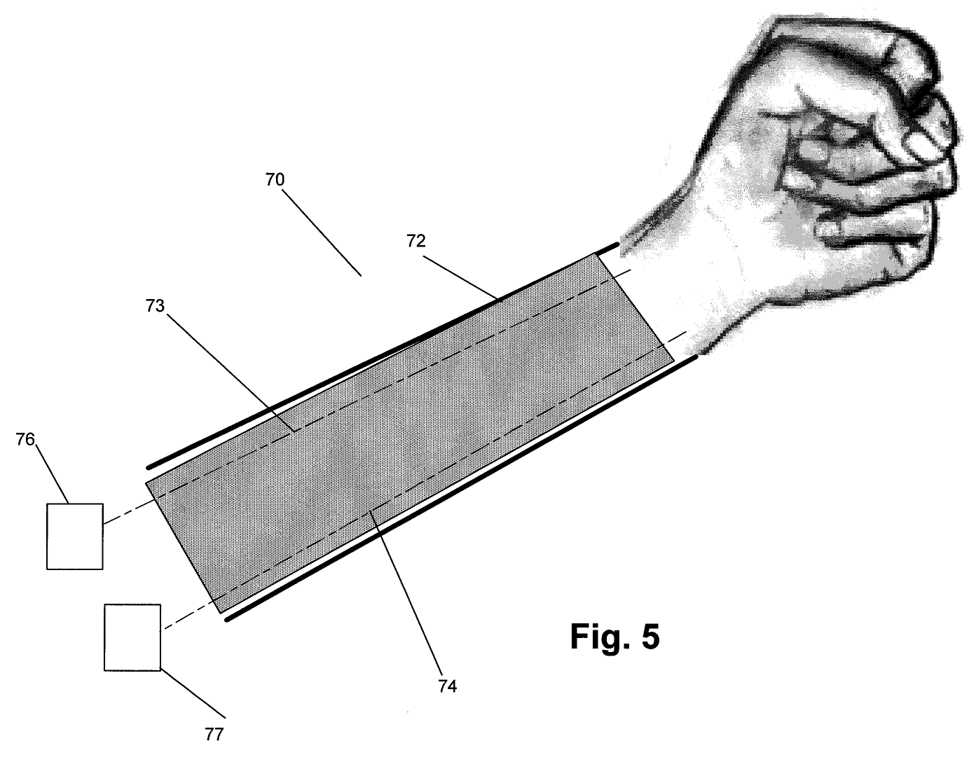

FIG. 5 is a block diagram of a flexible member based simulator 70 in accordance with another embodiment. Simulator 70 includes a model of an arm 72. Embedded under the artificial skin of arm 72 are one or more flexible members 73, 74, each coupled to a motor 76, 77. A processor (not shown) coupled to motors 76, 77 controls the tension in flexible members 73, 74, similar to simulator 10. In operation, simulator 70 can be set up in different modes to simulate different situations. For example, motors 76, 77 might control members 73, 74 in a pulsating manner so that they simulate arteries when a user encounters them while feeling arm 72. In another mode, the tension may be fixedly increased on members 73, 74 so that they simulate bones. Unlike simulator 10, in one embodiment the tension on members 73, 74 are not dependent on the position of the user's finger or an interface device.

As disclosed, a flexible member coupled to a motor allows the simulation of various body parts that have a sense of depth. However, embodiments can be used to simulate other objects. For example, embodiments can be used in cartography to allow a user to feel valleys and hills, or in weather-related fields to allow a user to feel high or low pressure regions, or to simulate anything that can be represented with contour lines/contour plots.

Several embodiments are specifically illustrated and/or described herein. However, it will be appreciated that modifications and variations of the present invention are covered by the above teachings and within the purview of the appended claims without departing from the spirit and intended scope of the invention.

What is claimed is:

1. A simulator comprising:
a motor;
a flexible member coupled to the motor and having a tension; and
a processor coupled to the motor, the processor adapted to control the motor to vary the tension of the flexible member.

2. The simulator of claim 1, further comprising a motion sensor coupled to the processor for monitoring a motion of the flexible member, wherein the processor controls the motor based on the motion.

3. The simulator of claim 2, further comprising a display coupled to the processor for displaying an image of an object to be simulated.

4. The simulator of claim 3, wherein the processor controls the motor based on the motion relative to the image.

5. The simulator of claim 1, wherein the flexible member is in contact with a user.

6. The simulator of claim 3, wherein the object to be simulated is at least a portion of a body.

7. The simulator of claim 5, wherein the tension causes the flexible member to feel like a tissue to the user.

8. The simulator of claim 5, wherein the tension causes the flexible member to feel like a bone to the user.

9. The simulator of claim 5, wherein the tension causes the flexible member to feel like a pulsating blood vessel to the user.

10. The simulator of 2, further comprising a data to be simulated.

11. The simulator of claim 10, wherein the data comprises contour lines.

12. A method of simulating an object comprising:
determining a feeling of a portion of the object; and
varying a tension of a flexible member to simulate the feeling.

13. The method of claim 12, further comprising monitoring a motion of the flexible member.

14. The method of claim 13, further comprising displaying an image of the object to be simulated.

15. The method of claim 14, wherein the varying the tension is based on the motion relative to the image.

16. The method of claim 12, wherein the object to be simulated is at least a portion of a body.

17. The method of claim 12, wherein the flexible member is in contact with a user.

18. The method of claim 17, wherein the tension causes the flexible member to feel like a tissue to the user.

19. The method of claim 17, wherein the tension causes the flexible member to feel like a bone to the user.

20. The method of claim 17, wherein the tension causes the flexible member to feel like a pulsating blood vessel to the user.

21. A user interface device comprising:
a motor;
a flexible member coupled to the motor and having a tension; and
a processor coupled to the motor, the processor adapted to control the motor to vary the tension of the flexible member.

22. A device for simulating an object comprising:
means for determining a feeling of a portion of the object; and
means for varying a tension of a flexible member to simulate the feeling.

23. The simulator of claim 6, wherein the tension allows the flexible member to contact a contact object when pressure is placed on the flexible member by the user.

24. The simulator of claim 23, wherein the contact object simulates a tumor.
